(19) United States
(12) Patent Application Publication
(10) Pub. No.: US 2025/0318026 A1
(43) Pub. Date: Oct. 9, 2025

(54) AEROSOL GENERATION APPARATUS AND MICROWAVE HEATING COMPONENT THEREOF

(71) Applicant: SMOORE INTERNATIONAL HOLDINGS LIMITED, George Town (KY)

(72) Inventors: Yonghai LAN, Shenzhen (CN); Zhenyong DENG, Shenzhen (CN); Jing DU, Shenzhen (CN); Yang DENG, Shenzhen (CN); Kunren YIN, Shenzhen (CN); Feng LIANG, Shenzhen (CN)

(21) Appl. No.: 19/245,951

(22) Filed: Jun. 23, 2025

Related U.S. Application Data
(63) Continuation of application No. PCT/CN2023/105311, filed on Jun. 30, 2023.

(30) Foreign Application Priority Data
Dec. 22, 2022 (CN) 202223444285.7
Apr. 14, 2023 (CN) 202310403843.5

(51) Int. Cl. H05B 6/80; A24F 40/46; H05B 6/72

(52) U.S. Cl. CPC H05B 6/80; A24F 40/46; H05B 6/725

(57) ABSTRACT

A microwave heating component for heating an aerosol-generating article includes: an outer conductor unit defining a cavity; an accommodating cavity formed in the cavity, the accommodating cavity having a central axis and for accommodating the aerosol-generating article; and an inner conductor unit arranged in the cavity, the inner conductor unit including a microwave radiation element. The microwave radiation element is arranged deviating from a central axis of the accommodating cavity and located on a periphery of the accommodating cavity. The microwave radiation element is rotatable around the central axis, or the aerosol-generating article is rotatable around the central axis of the accommodating cavity.

### CROSS-REFERENCE TO PRIOR APPLICATION

This application is a continuation of International Patent Application No. PCT/CN2023/105311, filed on Jun. 30, 2023, which claims priority to Chinese Patent Application No. 202310403843.5, filed on Apr. 14, 2023 and Chinese Patent Application No. 202223444285.7, filed on Dec. 22, 2022. The entire disclosure of the foregoing applications is hereby incorporated by reference herein.

### FIELD

The present disclosure relates to the technical field of aerosol generation, and in particular, to an aerosol generation apparatus and a microwave heating component thereof.

### BACKGROUND

The aerosol generation apparatus can heat and atomize an aerosol-generating article through microwave heating. The aerosol generation apparatus generally includes a microwave heating component. The microwave heating component can form a microwave interaction zone and transfer microwave energy to the aerosol-generating article. In this process, the distribution field of the microwave energy determines the effect of microwave heating.

The microwave heating component in the related art adopts a central heating method, that is, a probe is arranged at the center position of the cavity to heat the internal medium of the aerosol-generating article. This central heating method has the disadvantages of slow atomization speed and long preheating time, usually 5 seconds or more. During the puffing intervals, high-temperature heating needs to be maintained to keep the medium at a relatively high temperature.

### SUMMARY

In an embodiment, the present invention provides a microwave heating component for heating an aerosol-generating article, the microwave heating component comprising: an outer conductor unit defining a cavity; an accommodating cavity formed in the cavity, the accommodating cavity having a central axis and being configured to accommodate the aerosol-generating article; and an inner conductor unit arranged in the cavity, the inner conductor unit comprising a microwave radiation element, wherein the microwave radiation element is arranged deviating from a central axis of the accommodating cavity and located on a periphery of the accommodating cavity, and wherein the microwave radiation element is rotatable around the central axis, or the aerosol-generating article is rotatable around the central axis of the accommodating cavity.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is an overall schematic outside view of an aerosol generation apparatus according to the present disclosure.

FIG. 2 is a local schematic structural diagram of an aerosol generation apparatus with a housing omitted according to the present disclosure.

FIG. 3 is a longitudinal cross-sectional diagram of fitting between a driving assembly and a microwave heating component according to the present disclosure.

FIG. 4 is an exploded structural diagram of the driving assembly and the microwave heating component in FIG. 3.

FIG. 5 is a schematic structural diagram of an outer conductor unit according to the present disclosure.

FIG. 6 is a schematic structural diagram of an accommodating seat at a first angle according to the present disclosure.

FIG. 7 is a schematic structural diagram of an accommodating seat at a top-view angle according to the present disclosure.

FIG. 8 is a longitudinal cross-sectional diagram of fitting among a driving assembly, an accommodating seat and an aerosol-generating article according to the present disclosure.

FIG. 9 is a schematic structural diagram of fitting between a driving assembly and an accommodating seat according to the present disclosure.

FIG. 10 is a longitudinal cross-sectional diagram of a driven member of a driving assembly according to the present disclosure.

### DETAILED DESCRIPTION

In an embodiment, the present invention provides an improved aerosol generation apparatus and a microwave heating component thereof.

In an embodiment, the present invention provides a microwave heating component for heating an aerosol-generating article is provided, including:
an outer conductor unit defining a cavity;
an accommodating cavity formed in the cavity, having a central axis configured to accommodate the aerosol-generating article; and
an inner conductor unit arranged in the cavity and including a microwave radiation element, where the microwave radiation element is arranged deviating from the central axis of the accommodating cavity and located on the periphery of the accommodating cavity, and the microwave radiation element is rotatable around the central axis, or the aerosol-generating article is rotatable around the central axis of the accommodating cavity.

In some embodiments, the microwave radiation element is fixedly arranged relative to the outer conductor unit, the microwave heating component further includes a fixing member for fixing the aerosol-generating article, and the fixing member is rotatably arranged around the central axis of the accommodating cavity relative to the outer conductor unit to drive the aerosol-generating article fixed inside to rotate in the accommodating cavity.

In some embodiments, the microwave radiation element is rotatably arranged around the central axis of the accommodating cavity relative to the outer conductor unit.

In some embodiments, the microwave heating component further includes a fixing member for fixing the aerosol-generating article, and the fixing member is fixedly arranged relative to the outer conductor unit.

In some embodiments, the microwave heating component further includes a fixing member for fixing the aerosol-generating article, and the fixing member is rotatably arranged around the central axis of the accommodating cavity relative to the outer conductor unit.

In some embodiments, the central axis of the accommodating cavity is parallel to the central axis of the outer conductor unit.

In some embodiments, the microwave heating component further includes an accommodating seat, the accommodating seat includes an accommodating part arranged in the cavity and a slot for fitting with the microwave radiation element, the slot is formed in the accommodating part, and the accommodating cavity is formed in the accommodating part.

The present disclosure further provides an aerosol generation apparatus, including a microwave generation unit and the microwave heating component described above, where the microwave heating component further includes a microwave feed unit connected to the outer conductor unit, and the microwave feed unit is connected to the microwave generation unit and feeds microwaves generated by the microwave generation unit into the cavity.

In some embodiments, the aerosol generation apparatus further includes a driving assembly, and the driving assembly drives the microwave radiation element to rotate around the central axis of the accommodating cavity relative to the aerosol-generating article.

In some embodiments, the outer conductor unit may include the conductor side wall and the conductor end wall connected to the conductor side wall, the conductor end wall is provided with a connection part, and the microwave feed unit is connected to the connection part.

The present disclosure has the following beneficial effects: In the present disclosure, the microwave heating component includes an outer conductor unit, an inner conductor unit, and an accommodating cavity for accommodating an aerosol-generating article, the inner conductor unit includes a microwave radiation element, the microwave radiation element is arranged deviating from the central axis of the accommodating cavity and located on the periphery of the accommodating cavity, and the microwave radiation element is rotatable around the central axis, or the aerosol-generating article is rotatable around the central axis of the accommodating cavity, thereby achieving circumferential segmented heating, ensuring more even heating of the aerosol-generating article, improving the heating speed, increasing the atomization speed, and enabling immediate stop of heating after puffing by stopping heating during the puffing intervals.

In the following description, for the purpose of description rather than limitation, specific details such as the specific system structure and technology are provided to thoroughly understand the present disclosure. However, those skilled in the art should be aware that the present disclosure may also be implemented in other embodiments without these specific details. In other cases, detailed descriptions of well-known systems, apparatuses, circuits, and methods are omitted to avoid unnecessary details hindering the description of the present disclosure.

An embodiment of the present disclosure provides an aerosol generation apparatus 100. The aerosol generation apparatus 100 may be configured to heat an aerosol-generating article 200 through microwaves to atomize to generate an aerosol for users to puff or inhale.

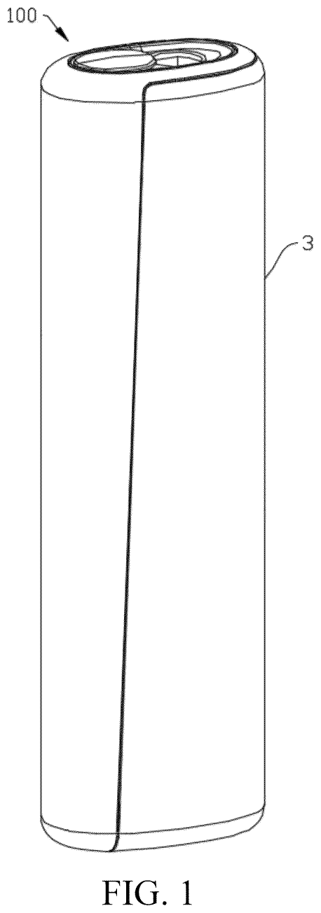

In some embodiments, referring to FIG. 1, the aerosol generation apparatus 100 may include a microwave heating component 1, a microwave generation unit, a control component 2, and a power supply component. The power supply component is configured to supply power to the microwave heating component 1, the microwave generation unit, and the control component 2. The control component 2 is configured to control the operation of the microwave heating component 1 and the microwave generation unit. The microwave generation unit may generate microwave signals and feed microwaves into the microwave heating component 1 through a connection with the microwave heating component 1. The microwave heating component 1 uses the microwaves to heat the aerosol-generating article 200.

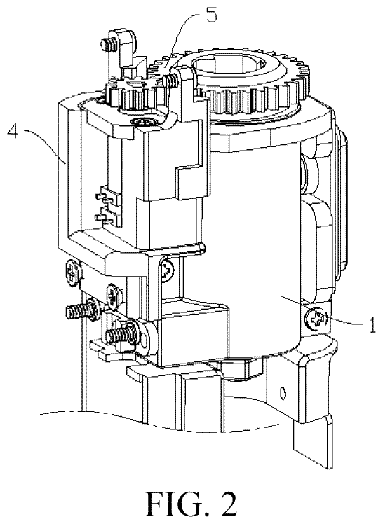

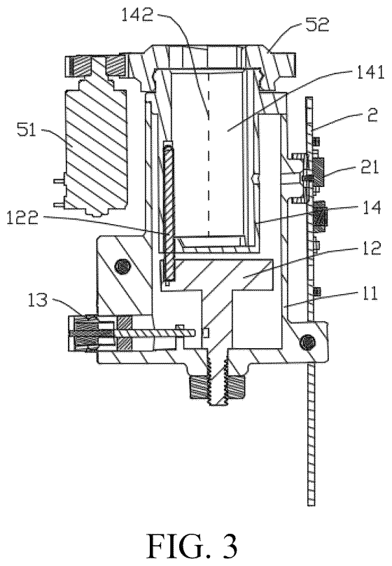

In some other embodiments, referring to FIG. 2 and FIG. 3 together, the aerosol generation apparatus 100 may include a microwave heating component 1, a microwave generation unit, a control component 2, a driving assembly 5, and a power supply component. The power supply component is configured to supply power to the microwave heating component 1, the microwave generation unit, the control component 2, and the driving assembly 5. The control component 2 is configured to control the operation of the microwave heating component 1, the microwave generation unit, and the driving assembly 5. The microwave generation unit may generate microwave signals and feed microwaves into the microwave heating component 1. The microwave heating component 1 uses the microwaves to locally heat the aerosol-generating article 200 in the circumferential direction, and uses the driving assembly 5 to drive the aerosol-generating article 200 to rotate relative to the microwave heating component 1, thereby achieving circumferential segmented heating, so as to overcome the problems of uneven heating and slow heating of the aerosol-generating article 200.

For example, the control component 2 includes an airflow sensor switch 21. During each puff, the airflow sensor switch 21 senses the change in airflow, and the driving assembly 5 is controlled to drive the aerosol-generating article 200 to rotate relative to the microwave heating component 1, so as to change an area where the aerosol-generating article 200 is heated in the circumferential direction.

Of course, the driving assembly 5 is not a necessary component of the present disclosure. In some embodiments, the relative rotation between the aerosol-generating article 200 and the microwave heating component 1 may also be achieved through manual control.

Referring to FIG. 1 and FIG. 2, optionally, the aerosol generation apparatus 100 may further include a housing 3 and a mounting bracket 4 arranged in the housing 3. The microwave heating component 1, the microwave generation unit, and the power supply component are mounted on the mounting bracket 4.

In some embodiments, the microwave heating component 1 is generally cylindrical. Of course, the microwave heating component 1 is not limited to being cylindrical, and it may also be in any other shape such as square column or elliptical column.

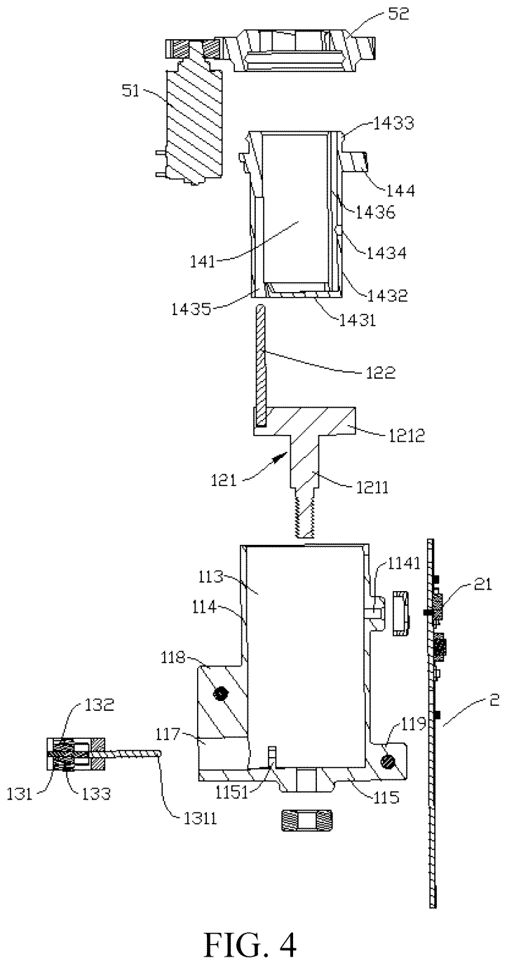

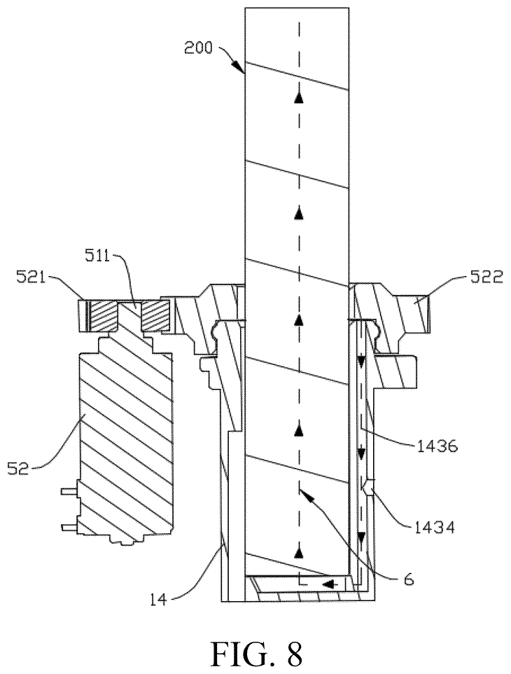

Referring to FIG. 3 and FIG. 4 together, the microwave heating component 1 may include an outer conductor unit 11, an inner conductor unit 12, and a microwave feed unit 13. The outer conductor unit 11 has the closed end 111 and the open end 112 opposite to the closed end 111, and may define the semi-closed cavity 113. An accommodating cavity 141 for accommodating the aerosol-generating article 200 is formed in the cavity 113. The accommodating cavity 141 has a central axis 142. The aerosol-generating article 200 (referring to FIG. 8) may be cylindrical. The inner conductor unit 12 includes an inner conductor body 121 and a microwave radiation element 122 combined with the inner conductor body 121. The inner conductor body 121 is connected to the closed end 111 of the outer conductor unit 11 and is in ohmic contact with the end wall of the closed end 111, thereby forming a short-circuit end of the microwave heating component 1. The microwave radiation element 122 is located in the cavity 113 but is not in contact with the outer conductor unit 11, thereby forming the open-circuit end of the microwave heating component 1. The microwave feed unit 13 is detachably mounted on the outer conductor unit 11, and is configured to feed the microwaves generated by the microwave generation unit into the cavity 113, thereby forming a microwave field that may act on the aerosol-generating article 200 in the cavity 113.

In some embodiments, the microwave heating component 1 may further include an accommodating seat 14, the accommodating seat 14 is fixedly or detachably mounted at the open end 112 of the outer conductor unit 11, the accommodating cavity 141 may be formed in the accommodating seat 14, and the accommodating cavity 141 is located in a main area where the microwave field is formed.

Of course, the accommodating seat 14 is not a necessary component in the present disclosure. The aerosol-generating article 200 may also be directly inserted into the cavity 113 from the open end 112 of the outer conductor unit 11. The accommodating seat 14 can protect the cavity 113 and the inner conductor body 121 from being contaminated by the aerosol as much as possible.

Referring to FIG. 3, the microwave radiation element 122 is arranged deviating from the central axis 142 of the accommodating cavity 141 and located on the periphery of the accommodating cavity 141. The microwave radiation element 122 can rotate around the central axis 142 of the accommodating cavity 141, or the aerosol-generating article 200 can rotate around the central axis 142 in the accommodating cavity 141 to achieve the circumferential segmented heating of the aerosol-generating article 200, thereby ensuring more even heating of the aerosol-generating article 200, improving the heating speed, and increasing the atomization speed without waiting. Since the atomization speed is fast, the preheating time is greatly reduced, and the heating can be stopped during the puffing intervals, thereby enabling immediate stop of heating after puffing.

It may be that the microwave radiation element 122 is relatively fixed, while the aerosol-generating article 200 is rotatable. Specifically, the microwave radiation element 122 is fixedly arranged relative to the outer conductor unit 11. Optionally, the microwave heating component 1 further includes a fixing member for fixing the aerosol-generating article 200, and the fixing member is rotatably arranged around the central axis 142 of the accommodating cavity 141 relative to the outer conductor unit 11 to drive the aerosol-generating article 200 fixed inside to rotate in the accommodating cavity 141. As can be understood, the aerosol-generating article 200 rotating relative to the accommodating cavity 141 may be that the inner conductor body 121, the microwave radiation element 122, and the accommodating seat 14 are fixedly arranged in the cavity 113, respectively, and when the aerosol-generating article 200 is inserted into the accommodating seat 14, the aerosol-generating article 200 is fixed relative to the accommodating seat 14 in an axial direction, and the driving assembly 5 directly acts on the aerosol-generating article 200 to drive the aerosol-generating article 200 to rotate on its own axis.

Optionally, it may also be that the microwave radiation element 122 is relatively rotatable, while the aerosol-generating article 200 is fixed. Specifically, the microwave radiation element 122 is rotatably arranged around the central axis 142 of the accommodating cavity 141 relative to the outer conductor unit 11. Optionally, the microwave heating component 1 further includes a fixing member for fixing the aerosol-generating article 200, and the fixing member is fixedly arranged relative to the outer conductor unit 11. As can be understood, it may be that the inner conductor body 121 and the microwave radiation element 122 is relatively fixed, the inner conductor body 121 and the microwave radiation element 122 are fixed relative to the cavity 113 in the axial direction, the inner conductor body 121 and the microwave radiation element 122 can rotate around the central axis of the cavity 113 under the drive of the driving assembly 5, the accommodating seat 14 is fixedly mounted on the outer conductor unit 11, the microwave radiation element 122 is located in the circumferential direction of the accommodating cavity 141, and when the aerosol-generating article 200 is inserted into the accommodating seat 14, the microwave radiation element 122 and the inner conductor body 121 can rotate together around the circumferential direction of the aerosol-generating article 200.

It may also be that the microwave radiation element 122 is relatively rotatable, while the aerosol-generating article 200 is also rotatable. Specifically, the microwave radiation element 122 is rotatably arranged around the central axis 142 of the accommodating cavity 141 relative to the outer conductor unit 11, the microwave heating component 1 further includes a fixing member for fixing the aerosol-generating article 200, and the fixing member is rotatably arranged around the central axis 142 of the accommodating cavity 141 relative to the outer conductor unit 11. As can be understood, it may be that the inner conductor body 121 is fixed on the closed end 111 of the outer conductor unit 11, the microwave radiation element 122 is fixed relative to the inner conductor body 121 in the axial direction, but the microwave radiation element 122 can rotate relative to the inner conductor body 121 in the circumferential direction under the drive of the driving assembly 5, the accommodating seat 14 is fixedly mounted on the outer conductor unit 11, the microwave radiation element 122 is located in the circumferential direction of the accommodating cavity 141, and when the aerosol-generating article 200 is inserted into the accommodating seat 14, the microwave radiation element 122 can rotate around the circumferential direction of the aerosol-generating article 200.

Second, the rotation direction of the aerosol-generating article 200 relative to the microwave heating component 1 may be determined according to the actual needs, and it may rotate around a single direction, for example, only clockwise or anticlockwise. It may also be that the rotation direction is switchable, for example, from clockwise to anticlockwise, or from anticlockwise to clockwise.

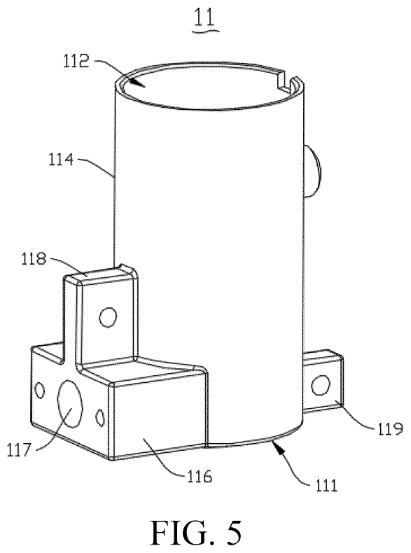

In some embodiments, referring to FIG. 4 and FIG. 5, the outer conductor unit 11 may include the conductor side wall 114, the conductor end wall 115, and the conductor convex wall 116.

The conductor side wall 114 may be cylindrical, the top end of the conductor side wall 114 is open to form the open end 112 of the outer conductor unit 11, the bottom end of the conductor side wall 114 is also open, and the conductor end wall 115 is integrally sealed at the bottom end of the conductor side wall 114 to form the closed end 111 of the outer conductor unit 11.

The conductor convex wall 116 is integrally combined with the outer periphery of the conductor side wall 114, and the bottom surface of the conductor convex wall 116 (the surface away from the open end 112 of the outer conductor unit 11) may be flush with the outer end surface of the conductor end wall 115.

A feeding hole 117 is formed in the conductor side wall 114 and the conductor convex wall 116. The feeding hole 117 is formed along a direction perpendicular to the central axis of the conductor side wall 114, runs straight through the conductor side wall 114 and the conductor convex wall 116, and is configured to allow the microwave feed unit 13 to be inserted into the cavity 113. Of course, the feeding hole 117 may also be formed in the conductor end wall 115, and the microwave feed unit 13 is inserted into the cavity 113 from a position below the microwave heating component 1.

The inner end surface of the conductor end wall 115 (the end face facing towards the open end 112 of the outer conductor unit 11) is formed with a connection part 1151 which protrudes. The connection part 1151 is configured to cooperate with the microwave feed unit 13 to feed the microwaves generated by the microwave feed unit 13 into the cavity 113.

Referring to FIG. 4, the conductor side wall 114 is provided with a protruding part which protrudes outwards and a first vent hole 1141 which runs through the protruding part and the conductor side wall 114. The first vent hole 1141 communicates the outside of the conductor side wall 114 with the cavity 113. Optionally, the first vent hole 1141 and the driving assembly 5 are respectively located on opposite sides of the conductor side wall 114 in the circumferential direction.

Referring to FIG. 5, the outer conductor unit 11 may further include a first fixing plate 118 and a second fixing plate 119 integrally combined with the outer periphery of the conductor side wall 114. The first fixing plate 118 and the second fixing plate 119 are configured to cooperate with the mounting bracket 4 to fix the entire outer conductor unit 11 on the mounting bracket 4. Optionally, the first fixing plate 118 and the second fixing plate 119 are located on two opposite sides of the conductor side wall 114, the first fixing plate 118 is integrally connected to the top of the conductor convex wall 116, the second fixing plate 119 is adjacent to the conductor end wall 115, and the bottom surface of the second fixing plate 119 (a surface away from the open end 112 of the outer conductor unit 11) is flush with the outer end surface of the conductor end wall 115.

In some embodiments, referring to FIG. 3, the central axis 142 of the accommodating cavity 141 may not overlap with the central axis of the inner conductor body 121, that is, it is biased away from the central axis of the inner conductor body 121. Optionally, the central axis 142 of the accommodating cavity 141 is parallel to the central axis of the inner conductor body 121. Of course, the accommodating cavity 141 may also be coaxial with the inner conductor body 121. The accommodating seat 14 is biased, so as to better achieve the circumferential segmented heating of the aerosol-generating article 200. There may be a gap between the bottom of the accommodating seat 14 and the top of the inner conductor body 121, and the two are not in direct contact.

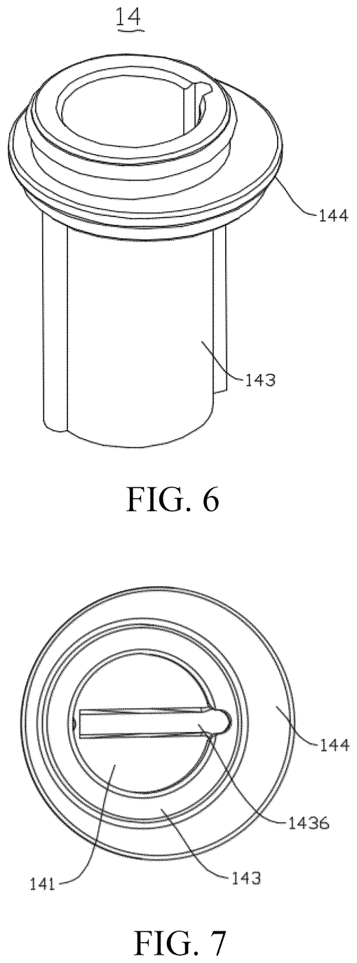

Referring to FIG. 4, FIG. 6, and FIG. 7 together, the accommodating seat 14 may include a fixing part 144 mounted at the open end 112 of the outer conductor unit 11, and an accommodating part 143 at least partially arranged in the cavity 113.

The accommodating part 143 may be cylindrical. Of course, the accommodating part 143 is not limited to being cylindrical, and may also be in any other shape such as a rectangular tube. The accommodating part 143 has a spacing from the cavity 113 in the circumferential direction. In addition, the outer diameter of the accommodating part 143 is smaller than the inner diameter of the cavity 113, and the inner diameter of the accommodating part 143 is adaptable to the outer diameter of the aerosol-generating article 200. The accommodating part 143 may include the accommodating bottom wall 1431 for supporting the aerosol-generating article 200, and the cylindrical accommodating side wall 1432 surrounding the periphery of the accommodating bottom wall 1431. The accommodating bottom wall 1431 and the accommodating side wall 1432 together form the accommodating cavity 141. The accommodating cavity 141 is cylindrical. A second vent hole 1434 for communication with the first vent hole 1141 is further formed in the accommodating side wall 1432. The second vent hole 1434 may be arranged opposite to the first vent hole 1141.

The fixing part 144 may be annular, is integrally combined with the outer periphery of the accommodating side wall 1432 of the accommodating part 143, and may be close to the top end of the accommodating side wall 1432. During assembling, the bottom end surface of the fixing part 144 (the end surface facing towards the closed end 111 of the outer conductor unit 11) is pressed against the open end 112 of the outer conductor unit 11, thereby allowing the accommodating seat 14 to be mounted on the outer conductor unit 11 and restricting the downward movement of the accommodating seat 14.

The accommodating seat 14 further includes a slot 1435 formed in the accommodating part 143. The slot 1435 runs through the accommodating bottom wall 1431, extends along a direction parallel to the central axis of the accommodating cavity 141 on the accommodating side wall 1432, runs through the accommodating bottom wall 1431 and the accommodating side wall, and is configured to cooperate with the microwave radiation element 122.

Referring to FIG. 4 and FIG. 7, the accommodating seat 14 further includes an air inlet channel 1436 formed in the accommodating part 143. The air inlet channel 1436 can not only introduce external air into the bottom of the aerosol-generating article 200, but also trigger the airflow sensor switch 21. The air inlet channel 1436 may include a first air channel formed in the accommodating bottom wall 1431 and a second air channel formed in the accommodating side wall 1432. The second vent hole 1434 is provided at a position corresponding to the second air channel on accommodating the side wall 1432. The second air channel may be in air guiding communication with the airflow sensor switch 21 through the second vent hole 1434. Optionally, the second air channel and the slot 1435 are respectively located on two opposite sides of the accommodating seat 14 in the circumferential direction.

As can be understood, referring to FIG. 8, when the aerosol-generating article 200 is inserted into the accommodating seat 14, the air inlet channel 1436 and the inside of the aerosol-generating article 200 together form an airflow channel 6, and external air may flow from the air inlet channel 1436 to the bottom of the aerosol-generating article, then vertically go upward from the bottom of the aerosol-generating article into the inside, and finally reach the top of the aerosol-generating article.

In some embodiments, referring to FIG. 4, the inner conductor body 121 includes a conductor column 1211 and a conductor disk 1212 integrally combined with the conductor column 1211.

The conductor column 1211 may be cylindrical and coaxially arranged in the cavity 113. In addition, the outer diameter of the conductor column 1211 is smaller than the inner diameter of the cavity 113. Of course, the conductor column 1211 is not limited to being cylindrical, and may also be in any other shape such as square column. The top end of the conductor column 1211 (the end close to the open end 112 of the outer conductor unit 11) is a free end, and extends towards the open end 112 of the outer conductor unit 11. The bottom end of the conductor column 1211 (the end far away from the open end 112 of the outer conductor unit 11) is a fixed end, and may be connected to the conductor end wall 115 of the outer conductor unit 11.

Optionally, the conductor column 1211 may include a mounting part for being mounted on the conductor end wall 115, and the mounting part is in threaded connection with the conductor end wall 115 to form a reliable ohmic contact. Of course, the conductor column 1211 may also be directly integrally combined with the conductor end wall 115.

The conductor disk 1212 is coaxially combined with the top end of the conductor column 1211. In addition, the outer diameter of the conductor disk 1212 is larger than the outer diameter of the conductor column 1211 and smaller than the diameter of the cavity 113. The radial distance from the conductor disk 1212 to the inner wall surface of the cavity 113 is much smaller than the radial distance from the conductor column 1211 to the inner wall surface of the cavity 113.

In some embodiments, referring to FIG. 3, the microwave radiation element 122 is biased away from the central axis of the inner conductor body 121, and may be located on the circumferential outer side of the aerosol-generating article 200.

Referring to FIG. 4 together, the microwave radiation element 122 may include a probe. The probe may be longitudinally elongated. One end of the probe is embedded into the top end of the conductor disk 1212 of the inner conductor body 121 (the end far away from the conductor column 1211), and the other end of the probe extends towards the open end 112 and stretches into the slot 1435 in the accommodating seat 14. The axis of the probe is parallel to the axis of the conductor disk 1212 and is biased away from the axis of the conductor disk 1212, so as to arrange the probe on the circumferential outer side of the aerosol-generating article 200 and collectively heat the local area in the circumferential direction of the aerosol-generating article 200.

Of course, the number of the probes may be adjusted according to the actual situation, and is not limited to one. Correspondingly, the number of the slots 1435 may be adjusted according to the set number of the probes.

In some embodiments, referring to FIG. 3, the microwave feed unit 13 may be a coaxial connector, one end of the microwave feed unit 13 is connected to the microwave generation unit through a coaxial joint or micro-strip line, and the other end of the microwave feed unit 13 is mounted on the outer conductor unit 11 and stretches into the cavity 113 to form an ohmic contact with the cavity 113.

Referring to FIG. 4, the microwave feed unit 13 may include an inner conductor 131, an outer conductor 132, and a dielectric layer 133 between the inner conductor 131 and the outer conductor 132.

The outer conductor 132 may be cylindrical, and both ends of the outer conductor 132 are designed to be open. During assembling, the outer peripheral side of the outer conductor 132 is in ohmic contact with the inner wall surface of the feeding hole 117.

The inner conductor 131 is a needle-like structure in the shape of a straight line. One end of the inner conductor 131 is a connecting end, is located inside the outer conductor 132, and is configured to connect to the microwave generation unit and the microwave. The other end of the inner conductor 131 is a feeding end 1311, is located outside the outer conductor 132, and may be located in the cavity 113 and connected to the connection part 1151 during assembling to form a good ohmic contact.

Of course, the feeding end 1311 of the inner conductor 131 is not limited to being in ohmic contact with the connection part 1151, and may also directly form ohmic contact with the inner conductor body 121. In addition, the inner conductor 131 is not limited to being in the shape of a straight line. The inner conductor 131 may also be L-shaped. For example, the inner conductor 131 may include a first segment perpendicular to the central axis 142 of the cavity 113 and a second segment parallel to the central axis 142 of the cavity 113. The first segment is located in the outer conductor 132 and is integrally connected to one end of the second segment. The other end of the second segment is arranged outside the outer conductor 132 and is in direct ohmic contact with the conductor end wall 115 of the outer conductor unit 11.

Referring to FIG. 2 and FIG. 3, in some embodiments, the driving assembly 5 is mounted on the accommodating seat 14 and fit with the aerosol-generating article 200. The driving assembly 5 may drive the aerosol-generating article 200 to rotate around the central axis 142 of the accommodating cavity 141.

Referring to FIG. 8, the driving assembly 5 includes a driving member and a transmission unit 52. The driving member is electrically connected to the control component 2. The operation of the driving member is controlled by the control component 2. When the driving member works, the driving member drives the transmission unit 52, and under the drive of the transmission unit 52, the aerosol-generating article 200 rotates, so that the aerosol-generating article 200 can rotate on its own central axis. Of course, the transmission unit 52 may also drive to rotate through manual control, thereby driving the aerosol-generating article 200 to rotate. As can be understood, a driving motor 51, under the control of the control component 2, may drive the aerosol-generating article 200 to rotate a preset angle when the atomizable medium is puffed each time. For example, for each puff, the aerosol-generating article 200 rotates an angle of 30°, and twelve puffs may complete one circle. Of course, the preset angle may be adjusted according to the actual situation, and is not limited to 30°, which will not be specifically limited here.

The driving member is fixedly mounted on the mounting bracket 4, and the driving assembly may be the driving motor 51. A rotating shift 511 of the driving motor 51 is parallel to the central axis of the accommodating cavity 141. Optionally, the driving motor 51 may include a stepping motor.

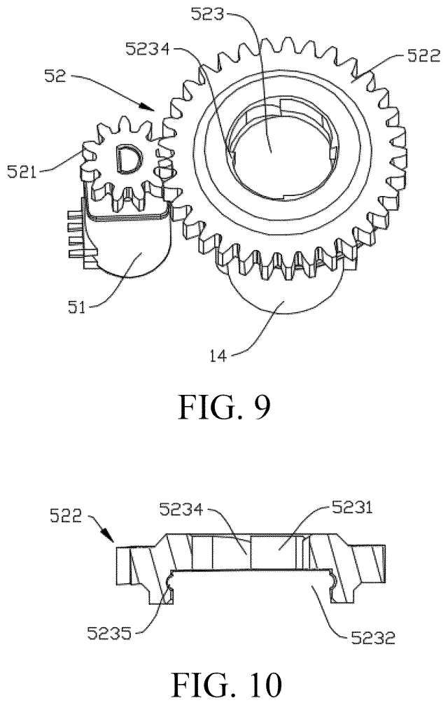

Referring to FIG. 8 and FIG. 9, the transmission unit 52 may include a drive member 521 mounted on the rotating shaft 511 of the driving motor 51, and a driven member 522 that can rotate around the central axis 142 of the accommodating seat 14 and is mounted on the accommodating seat 14. The drive member 521 cooperates with the driven member 522 to transmit the power generated by the driving motor 51 to the driven member 522.

Optionally, the transmission unit 52 may be a gear transmission structure, which may include a drive gear (drive member 521) fixed on the rotating shaft 511 of the driving member and a driven gear (driven member 522) mounted on the accommodating seat 14. The drive gear may rotate synchronously with the rotating shaft 511 of the driving motor 51. The driven gear is rotatably fitted on the accommodating seat 14 and can rotate relative to the accommodating seat 14. The drive gear and the driven gear are engaged with each other, and a plane where they are located is perpendicular to the central axis of the outer conductor unit 11. The inner circumference of the driven gear may be pressed against the aerosol-generating article 200 inserted into the accommodating seat 14, and be fixed relative to the aerosol-generating article 200.

The circumferential outermost side of the driven gear is formed with multiple teeth for engagement with the drive gear. The driven gear is also formed with a through hole 523. The through hole 523 may be communicated with the accommodating cavity 141 after assembling. The aerosol-generating article 200 may pass through the through hole 523 to stretch into the accommodating cavity 141.

Referring to FIG. 10, the through hole 523 includes a first hole segment 5231 and a second hole segment 5232 coaxially connected to the first hole segment 5231.

The first hole segment 5231 is located at the top of the accommodating seat 14, and several fixed teeth 5234 are formed on a peripheral wall of the first hole segment 5231. These fixed teeth 5234 form an aperture smaller than the outer diameter of the aerosol-generating article 200, and are configured to clamp the circumferential surface of the aerosol-generating article 200, so that the aerosol-generating article 200 is relatively fixed with the driven gear and the aerosol-generating article 200 can rotate synchronously with the driven gear. Optionally, these fixed teeth 5234 may be pawl teeth, and are formed along the circumferential surface of the first hole segment 5231 and spaced apart along the same direction.

The aperture of the second hole segment 5232 is larger than that of the first hole segment 5231 and is adapted to the outer diameter of the accommodating part 143, so that a step is formed between the first hole segment 5231 and the second hole segment 5232. During assembling, the second hole segment 5232 is fitted on the outer periphery of the accommodating part 143, and a step surface is pressed against the top end of the accommodating part 143. Preferably, the second hole segment 5232 is further formed with a groove 5235 formed on its circumferential wall around its circumferential direction, and the groove 5235 is annular and is configured to cooperate with a flange 1433 formed on the accommodating part 143. During assembling, the flange 1433 may be clamped into the groove 5235, and the size of the flange 1433 is slightly smaller than that of the groove 5235. There is a gap between the flange 1433 and the groove 5235, so that the driven gear can rotate relative to the accommodating seat 14. The design of the groove 5235 and the flange 1433 not only can ensure the reliable mounting of the driven gear on the accommodating part 143, but also can reduce the rotational contact area between the driven gear and the accommodating part 143, and reduce the frictional resistance during rotation.

Of course, the drive gear and the driven gear may be directly engaged, or connected through one or several driven gears for transmission between the drive gear and the driven gear. Whether to arrange the driven gears and the number of the driven gears may be determined by setting and adjusting the number of the driven gears according to factors such as the preset angle of rotation of the aerosol-generating article 200, and the position relationship between the driving member and the accommodating seat 14.

Optionally, the transmission unit 52 may be a belt transmission unit, which may include a drive wheel (drive member 521), a driven wheel (driven member 522), and a belt, the drive wheel and the driven wheel are perpendicular to the central axis of the accommodating cavity 141, the drive wheel is fixed on the rotating shaft 511 of the driving motor 51, and the driven wheel is mounted on the accommodating seat 14 and located above the accommodating seat 14. In addition, the driven wheel is formed with a through hole 523 and several fixed teeth 5234 (referring to the fixed teeth 5234 formed on the movable part) provided at the through hole 523, and when the aerosol-generating article 200 passes through the driven wheel and is inserted into the accommodating seat 14, the driven wheel is fixed relative to the aerosol-generating article 200 through the several fixed teeth 5234. By tensioning the belt on the drive wheel and the driven wheel, power may be transmitted to the driven wheel, and the driven wheel drives the aerosol-generating article 200 to rotate synchronously.

Optionally, the transmission unit 52 may be a chain transmission unit, which may include a drive wheel (drive member 521), a driven wheel (driven member 522), and a chain, the drive wheel and the driven wheel are perpendicular to the central axis of the accommodating cavity 141, the drive wheel is fixed on the rotating shaft 511 of the driving motor 51, and the driven wheel is mounted on the accommodating seat 14 and located above the accommodating seat 14. In addition, the driven wheel is formed with a through hole 523 and several fixed teeth 5234 (referring to the fixed teeth 5234 formed on the movable part) provided at the through hole 523, and when the aerosol-generating article 200 passes through the driven wheel and is inserted into the accommodating seat 14, the driven wheel is fixed relative to the aerosol-generating article 200 through the several fixed teeth 5234. Power may be transmitted to the driven wheel through the chain, and the driven wheel drives the aerosol-generating article 200 to rotate synchronously.

Optionally, the transmission unit 52 may be a ratchet transmission unit, which may include a swinging rod fixed on the rotating shaft 511 of the driving member, a pawl connected to the swinging rod, and a ratchet sleeve mounted above the accommodating seat 14, a plane where the ratchet sleeve is located is perpendicular to the central axis of the accommodating cavity 141, the ratchet sleeve is formed with a through hole 523 and several fixed teeth 5234 (referring to the fixed teeth 5234 formed on the movable part) provided at the through hole 523, and when the aerosol-generating article 200 passes through the ratchet sleeve and is inserted into the accommodating seat 14, the ratchet sleeve is fixed relative to the aerosol-generating article 200 through the several fixed teeth 5234. As can be understood, the swinging rod drives the pawl to swing back and forth, the pawl pokes the ratchet sleeve to make a unidirectional intermittent motion, and the aerosol-generating article 200 rotates synchronously with the ratchet sleeve.

In some embodiments, the mounting bracket 4 may be a metal bracket made of a metal material that has a heat conducting effect. Referring to FIG. 2, the mounting bracket 4 includes a first bracket part for mounting the microwave heating component 1 and a second bracket part for mounting the driving motor 51 of the driving assembly 5.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A microwave heating component for heating an aerosol-generating article, the microwave heating component comprising:
an outer conductor unit defining a cavity;
an accommodating cavity formed in the cavity, the accommodating cavity having a central axis and being configured to accommodate the aerosol-generating article; and
an inner conductor unit arranged in the cavity, the inner conductor unit comprising a microwave radiation element,
wherein the microwave radiation element is arranged deviating from a central axis of the accommodating cavity and located on a periphery of the accommodating cavity, and
wherein the microwave radiation element is rotatable around the central axis, or the aerosol-generating article is rotatable around the central axis of the accommodating cavity.

2. The microwave heating component of claim 1, wherein the microwave radiation element is fixedly arranged relative to the outer conductor unit, and
wherein the microwave heating component further comprising a fixing member configured to fix the aerosol-generating article, the fixing member being rotatably arranged around the central axis of the accommodating cavity relative to the outer conductor unit so as to drive the aerosol-generating article fixed inside thereof to rotate in the accommodating cavity.

3. The microwave heating component of claim 1, wherein the microwave radiation element is rotatably arranged around the central axis of the accommodating cavity relative to the outer conductor unit.

4. The microwave heating component of claim 3, further comprising:
a fixing member configured to fix the aerosol-generating article, the fixing member being fixedly arranged relative to the outer conductor unit.

5. The microwave heating component of claim 3, further comprising:
a fixing member configured to fix the aerosol-generating article, the fixing member being rotatably arranged around the central axis of the accommodating cavity relative to the outer conductor unit.

6. The microwave heating component of claim 1, wherein the central axis of the accommodating cavity is parallel to a central axis of the outer conductor unit.

7. The microwave heating component of claim 1, further comprising:
an accommodating seat comprising an accommodating part arranged in the cavity and a slot configured to fit with the microwave radiation element, the slot being formed in the accommodating part, the accommodating cavity being formed in the accommodating part.

8. An aerosol generation apparatus, comprising:
a microwave generation unit; and
the microwave heating component of claim 1, the microwave heating component further comprising:
a microwave feed unit connected to the outer conductor unit, the microwave feed unit being connected to the microwave generation unit and being configured to feed microwaves generated by the microwave generation unit into the cavity.

9. The aerosol generation apparatus of claim 8, further comprising:
a driving assembly configured to drive the microwave radiation element to rotate around the central axis of the accommodating cavity relative to the aerosol-generating article.

10. The aerosol generation apparatus of claim 8, wherein the outer conductor unit comprises an conductor side wall and a conductor end wall connected to the conductor side wall,
wherein the conductor end wall is provided with a connection part, and
wherein the microwave feed unit is connected to the connection part.
